(19) United States
(12) Patent Application Publication
(10) Pub. No.: US 2014/0098550 A1
(43) Pub. Date: Apr. 10, 2014

(54) Light Adjustable Car Threshold Pedal

(71) Applicant: Hon Yu Auto Parts Co., Ltd., New Taipei City (TW)

(72) Inventor: Yin-Teng HSIAO, New Taipei City (TW)

(73) Assignee: Hon Yu Auto Parts Co., Ltd., New Taipei City (TW)

(21) Appl. No.: 13/960,579

(22) Filed: Aug. 6, 2013

(30) Foreign Application Priority Data
Oct. 4, 2012 (TW) 101219152

(51) Int. Cl. B60Q 3/02

(52) U.S. Cl. CPC B60Q 3/0293
USPC 362/464

(57) ABSTRACT

A light adjustable car threshold pedal contains at least one light-emitting pedal assembly, a controlling unit, and an input unit. Each includes a body, a first light penetrating element disposed on the body, a second light penetrating element fixed on the body, a first illuminating element for emitting lights to the first light penetrating element, and a second illuminating element for emitting lights to the second light penetrating element. The controlling unit is electrically connected with the first illuminating element and the second illuminating element so as to turn on/off the first illuminating element and the second illuminating element and to control luminance of the first illuminating element and the second illuminating element. The input unit is electrically connected with the controlling unit so as to control a varying illumination of the first illuminating element and the second illuminating element.

### FIELD OF THE INVENTION

The present invention relates to a light adjustable car threshold pedal which when a car door is opened/closed or a car engine is started or a lamp in the car is turned on/off, the two illumination portions of each light-emitting pedal assembly controls a power source and a light luminance, and the light controller is used to control the two illumination portions of each light-emitting pedal assembly so as to change the light luminance.

### BACKGROUND OF THE INVENTION

A conventional light emitting device for a car emits decorative light and illuminative light, wherein the decorative light emits from a first emitting element fixed on an invisible portion of the car so as to vary illumination, and the illuminative light illuminates from visible portions of the car so as to make the driver and passengers clearly view objects in the car.

For example, at least one light accessory is mounted on a floor or a door threshold of the car so as to vary illumination and/or to make the driver and passengers clearly view objects in the car.

The present invention has arisen to mitigate and/or obviate the afore-described disadvantages.

### SUMMARY OF THE INVENTION

The primary object of the present invention is to provide a light adjustable car threshold pedal which when a car door is opened/closed or a car engine is started or a lamp in the car is turned on/off, two illumination portions of each light-emitting pedal assembly controls a power source and a light luminance.

Another object of the present invention is to provide a light adjustable car threshold pedal which also contains a light controller for controlling the two illumination portions of each light-emitting pedal assembly so as to change the light luminance.

To obtain the above objectives, a light adjustable car threshold pedal provided by the present invention contains: at least one light-emitting pedal assembly, a controlling unit, and an input unit.

Each includes a body, a first light penetrating element disposed on the body, a second light penetrating element fixed on the body, a first illuminating element for emitting lights to the first light penetrating element, and a second illuminating element for emitting lights to the second light penetrating element.

The controlling unit is electrically connected with the first illuminating element and the second illuminating element so as to turn on/off the first illuminating element and the second illuminating element and to control luminance of the first illuminating element and the second illuminating element.

The input unit is electrically connected with the controlling unit so as to control a varying illumination of the first illuminating element and the second illuminating element.

Preferably, the first light penetrating element has a light transmitting shell and a light reflecting plate coupling with the light transmitting shell.

Preferably, the first illuminating element is a lighting panel comprised of a plurality of light-emitting diodes.

Preferably, the first illuminating element is a lighting panel comprised of a plurality of bulbs.

Preferably, the second light penetrating element is a strapped light transmitting plate.

Preferably, the second light penetrating element having a light guiding bar coupled with a second illuminating element.

Preferably, the second illuminating element is selected from the group consisting of a light-emitting diode and a bulb.

Preferably, the light adjustable car threshold pedal further comprising a light controller electrically connected with the controlling unit so as to adjust a varying illumination of the first illuminating element and the second illuminating element.

Preferably, the light controller is wirely connected with the controlling unit.

Preferably, the light controller is a remote control.

Preferably, the light controller includes a touch panel.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a diagram of a light adjustable car threshold pedal according to a first embodiment of the present invention.

FIG. 2 is a perspective view showing the assembly of the light adjustable car threshold pedal according to the first embodiment of the present invention.

FIG. 3A is a perspective view showing the exploded components of the light adjustable car threshold pedal according to the first embodiment of the present invention.

FIG. 3B is a perspective view showing the exploded components of the light adjustable car threshold pedal according to the first embodiment of the present invention.

FIG. 4A is a diagram showing the operation of the light adjustable car threshold pedal according to the first embodiment of the present invention.

FIG. 4B is a diagram showing the operation of the light adjustable car threshold pedal according to the first embodiment of the present invention.

### DETAILED DESCRIPTION OF THE PREFERRED EMBODIMENTS

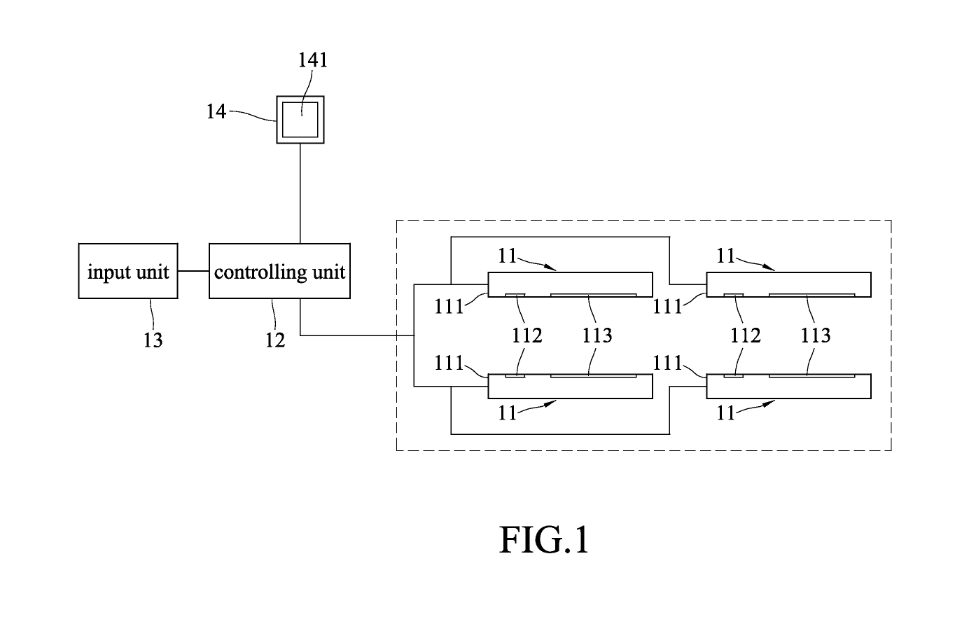

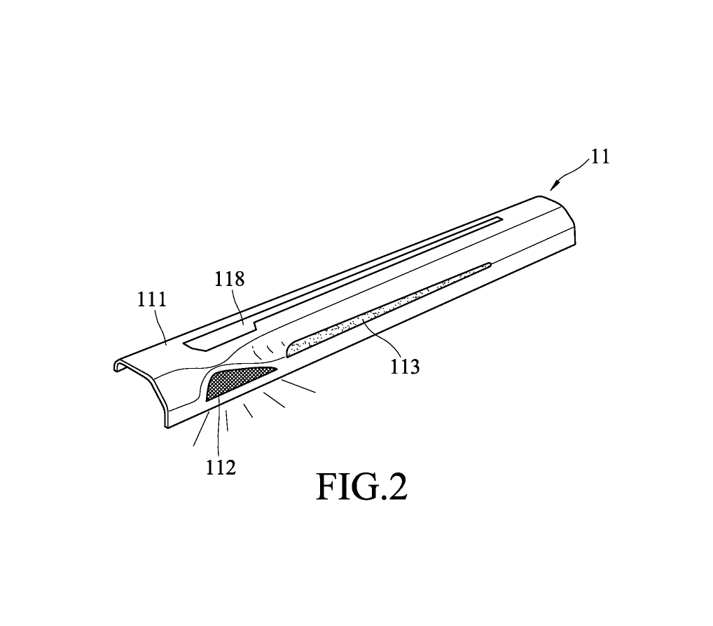

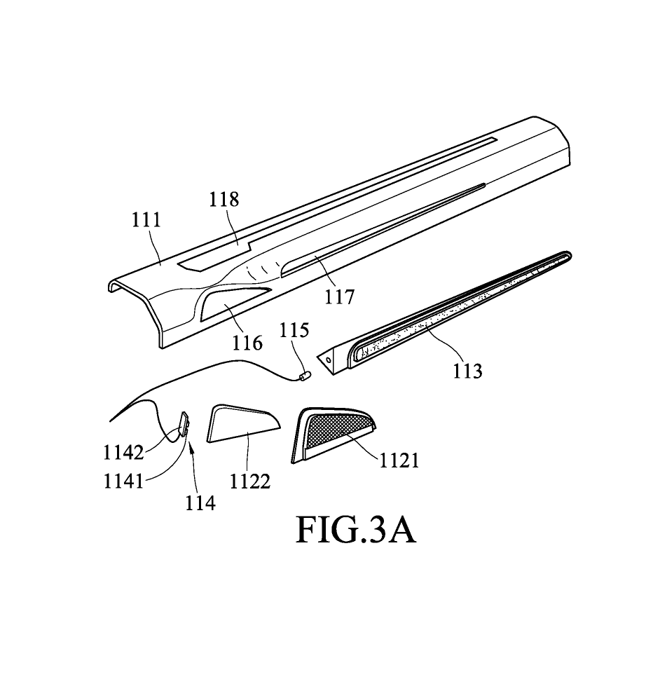

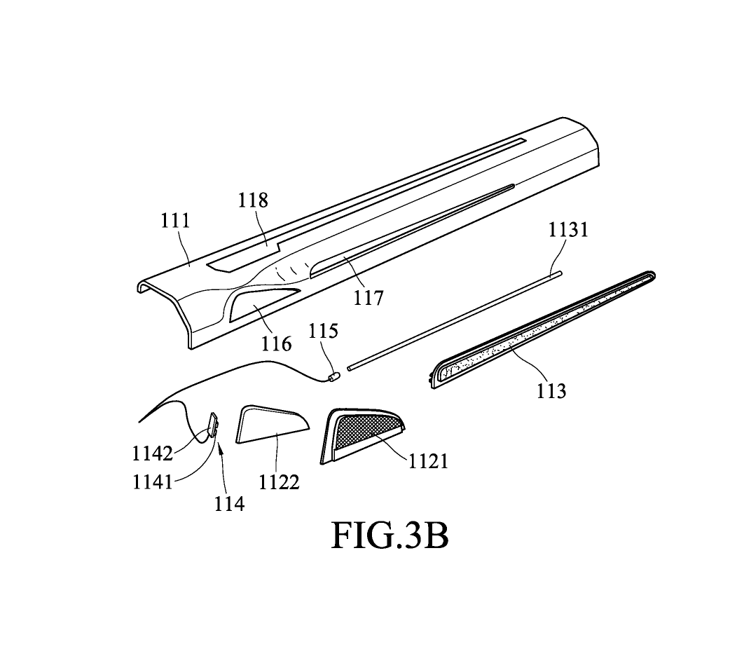

FIG. 1 is a diagram of a light adjustable car threshold pedal according to a first embodiment of the present invention. FIG. 2 is a perspective view showing the assembly of the light adjustable car threshold pedal according to the first embodiment of the present invention. FIG. 3A is a perspective view showing the exploded components of the light adjustable car threshold pedal according to the first embodiment of the present invention. With reference to FIGS. 1, 2, and 3A, a light adjustable car threshold pedal according to a preferred embodiment of the present invention comprises at least one light-emitting pedal assembly 11, a controlling unit 12, an input unit 13, and a light controller 14.

Each light-emitting pedal assembly 11 includes a body 111, a first light penetrating element 112 disposed on the body 111, a second light penetrating element 113 fixed on the body 111, a first illuminating element 114 for emitting lights to the first light penetrating element 112, and a second illuminating element 115 for emitting lights to the second light penetrating element 113, wherein the body 111 has a first receiving hole 116 for fixing the first light penetrating element 112 and has a second receiving hole 117 for fixing the second light penetrating element 113, such that each light-emitting pedal assembly 11 obtains two illumination portions. In addition, the body 111 also has a decoration piece 118 mounted thereon, and the decoration piece 118 is made of metal material, plastic material or composite material of metal and plastic.

The controlling unit 12 is electrically connected with the first illuminating element 114 and the second illuminating element 115 so as to turn on/off the first illuminating element 114 and the second illuminating element 115 and to control luminance of the first illuminating element 114 and the second illuminating element 115.

The input unit 13 is electrically connected with the controlling unit 12 so as to control a varying illumination of the first illuminating element 114 and the second illuminating element 115.

Also, the light controller 14 is electrically connected with the controlling unit 12 so as to adjust the varying illumination of the first illuminating element 114 and the second illuminating element 115, wherein the light controller 14 is wirely connected with the controlling unit 12 or the light controller 14 is a remote control and includes a touch panel 141.

Referring further to FIG. 3A, the first light penetrating element 112 has a light transmitting shell 1121 and a light reflecting plate 1122 coupling with the light transmitting shell 1121. The first illuminating element 114 is a lighting panel 1142 comprised of a plurality of light-emitting diodes or bulbs 1141, and the second light penetrating element 113 is a strapped light transmitting plate, such that when the first illuminating element 114 illuminates, the first light penetrating element 112 emits lights brightly.

FIG. 3B is a perspective view showing the exploded components of the light adjustable car threshold pedal according to the first embodiment of the present invention. A difference of a light adjustable car threshold pedal of a second embodiment from that of the first embodiment comprises: a second light penetrating element 113 having a light guiding bar 1131 coupled with a second illuminating element 115, wherein the second illuminating element 115 is a light-emitting diode or a bulb, such that when the first illuminating element 114 illuminates, the second light penetrating element 113 emits more gently decorative lights than the first light penetrating element 112.

Thereby, the two illumination portions of each light-emitting pedal assembly 11 are capable of turning on/off the first illuminating element 114 and the second illuminating element 115 and controlling the luminance of the first illuminating element 114 and the second illuminating element 115 by means of the input unit 13. It is to be noted that the input unit 13 is an interior control system of a car, so when a car door is opened/closed or a car engine is started or a lamp in the car is turned on/off, the two illumination portions control a power source and a light luminance. Furthermore, the light controller 14 is used to control the two illumination portions of the each light-emitting pedal assembly 11 so as to change the light luminance.

In other words, when the input unit 13 operates to open/close the car door or to start the car engine or to turn on/off the light in the car or when the light controller 14 operates, the first illuminating element 114 and the second illuminating element 115 are controlled by the input unit 13 to turn on/off the lamp of the car or to change the light luminance, and the light penetrates through the first light penetrating element 112 and the second light penetrating element 113 to illuminate the car.

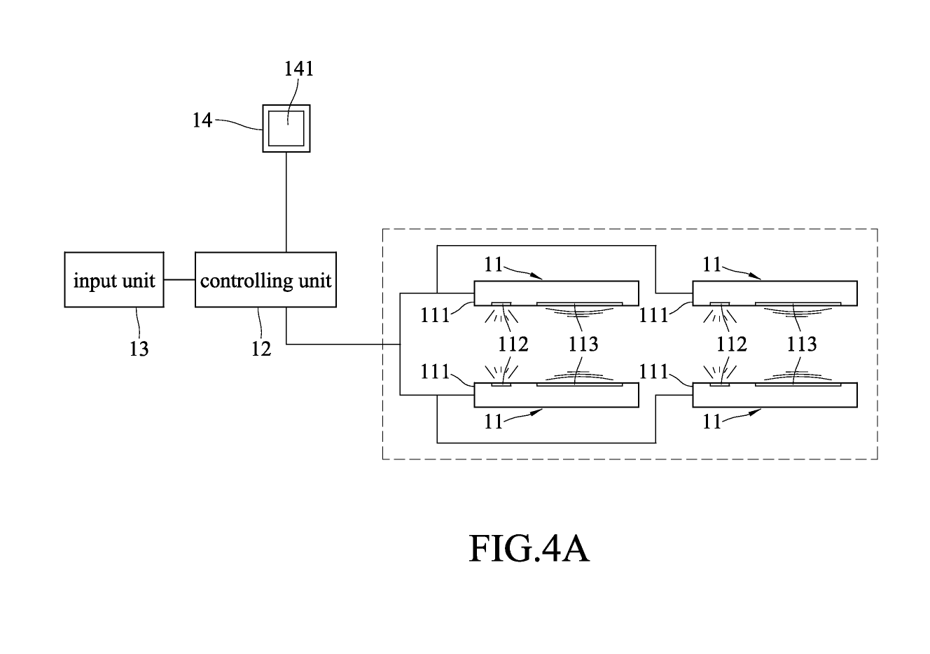

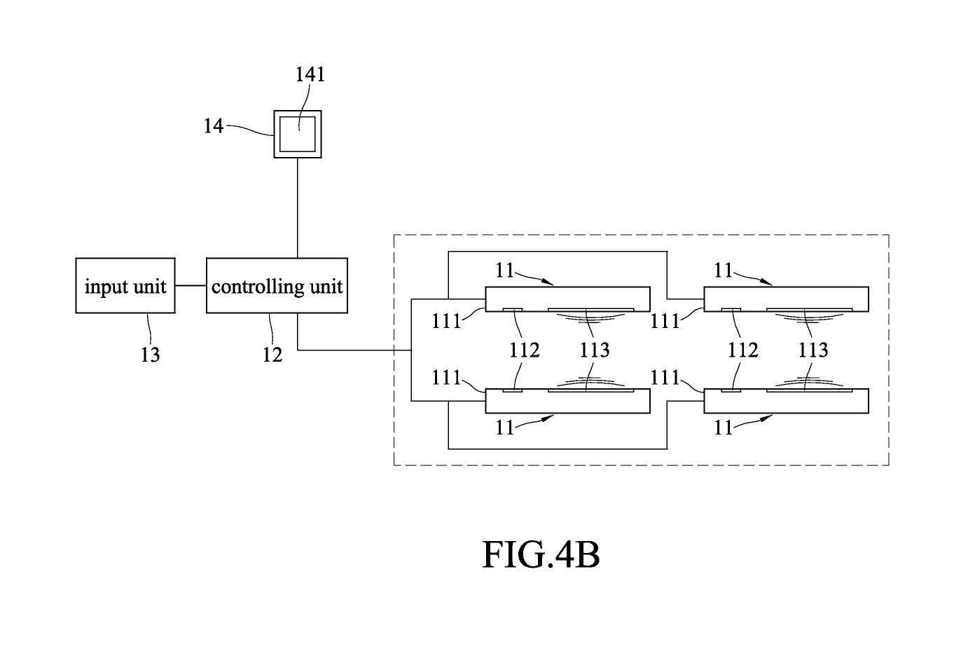

FIGS. 4A and 4B are diagrams showing the operation of the light adjustable car threshold pedal according to the first embodiment of the present invention. As shown in FIGS. 4A and 4B, four light-emitting pedal assemblies 11 are fixed on two sides of a front side and a rear side of the car, and each of the four light-emitting pedal assemblies 11 is electrically connected with the controlling unit 12, such that when the car door is opened or the car engine is started or the lamp in the car is turned on, the power source is started by the controlling unit 12 to light the first illuminating element 114 and the second illuminating element 115 of the each of the four light-emitting pedal assemblies 11 so that the first light penetrating element 112 emits an illuminative light to a floor of the car, and the second light penetrating element 113 generates a decorative light simultaneously (as illustrated in FIG. 4A).

After the car door is closed or the car engine is started or the lamp in the car is turned off, the controlling unit 12 controls the first illuminating element 114 to power off, and the second illuminating element 115 still emits light, such that the each of the four light-emitting pedal assemblies 11 keeps the decorative light from the second light penetrating element 113 (as illustrated in FIG. 4B). Thereafter, the decorative light emits or distinguishes by setting the controlling unit 12 after powering off the power source or stopping the car engine.

However, FIGS. 4A and 4B only show an operation example of the light adjustable car threshold pedal of the present invention. The controlling unit 12 is also capable of being set to control the varying illumination of the first illuminating element 114 and the second illuminating element 115, such as operating time, luminance, and color.

Also, a driver is capable of controlling the varying illumination of the two illumination portions of the at least one light-emitting pedal assemblies 11 based on using requirement by using the light controller 14.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A light adjustable car threshold pedal comprising:
at least one light-emitting pedal assembly including a body, a first light penetrating element disposed on the body, a second light penetrating element fixed on the body, a first illuminating element for emitting lights to the first light penetrating element, and a second illuminating element for emitting lights to the second light penetrating element;
a controlling unit electrically connected with the first illuminating element and the second illuminating element so as to turn on/off the first illuminating element and the second illuminating element and to control luminance of the first illuminating element and the second illuminating element;
an input unit electrically connected with the controlling unit so as to control a varying illumination of the first illuminating element and the second illuminating element.

2. The light adjustable car threshold pedal as claimed in claim 1, wherein the first light penetrating element has a light transmitting shell and a light reflecting plate coupling with the light transmitting shell.

3. The light adjustable car threshold pedal as claimed in claim 1, wherein the first illuminating element is a lighting panel comprised of a plurality of light-emitting diodes.

4. The light adjustable car threshold pedal as claimed in claim 1, wherein the first illuminating element is a lighting panel comprised of a plurality of bulbs.

5. The light adjustable car threshold pedal as claimed in claim 2, wherein the first illuminating element is a lighting panel comprised of a plurality of light-emitting diodes.

6. The light adjustable car threshold pedal as claimed in claim 2, wherein the first illuminating element is a lighting panel comprised of a plurality of bulbs.

7. The light adjustable car threshold pedal as claimed in claim 1, wherein the second light penetrating element is a strapped light transmitting plate.

8. The light adjustable car threshold pedal as claimed in claim 1, wherein the second light penetrating element having a light guiding bar coupled with a second illuminating element.

9. The light adjustable car threshold pedal as claimed in claim 1, wherein the second illuminating element is selected from the group consisting of a light-emitting diode and a bulb.

10. The light adjustable car threshold pedal as claimed in claim 7, wherein the second illuminating element is selected from the group consisting of a light-emitting diode and a bulb.

11. The light adjustable car threshold pedal as claimed in claim 8, wherein the second illuminating element is selected from the group consisting of a light-emitting diode and a bulb.

12. The light adjustable car threshold pedal as claimed in claim 1 comprising a light controller electrically connected with the controlling unit so as to adjust a varying illumination of the first illuminating element and the second illuminating element.

13. The light adjustable car threshold pedal as claimed in claim 12, wherein the light controller is wirely connected with the controlling unit.

14. The light adjustable car threshold pedal as claimed in claim 12, wherein the light controller is a remote control.

15. The light adjustable car threshold pedal as claimed in claim 13, wherein the light controller includes a touch panel.

16. The light adjustable car threshold pedal as claimed in claim 14, wherein the light controller includes a touch panel.
